(19) United States
(12) Patent Application Publication
(10) Pub. No.: US 2009/0086844 A1
(43) Pub. Date: Apr. 2, 2009

(54) Method And System For A Programmable Local Oscillator Generator Utilizing A DDFS For Extremely High Frequencies

(76) Inventor: Ahmadreza Rofougaran, Newport Coast, CA (US)

Correspondence Address: MCANDREWS HELD & MALLOY, LTD, 500 WEST MADISON STREET, SUITE 3400, CHICAGO, IL, 60661, US

(21) Appl. No.: 11/864,829

(22) Filed: Sep. 28, 2007

(51) Int. Cl. H04L 27/00

(52) U.S. Cl. 375/295

(57) ABSTRACT

Methods and systems for a programmable LO generator utilizing a DDFS for extremely high frequencies are disclosed. Aspects of one method may include generating a first signal and a second signal using a base signal. The DDFS may generate the first signal, where the base signal may be divided down to provide a reference clock for the DDFS. The base signal may be divided to a lower frequency to generate the second signal. The first and second signals may be mixed to generate a third signal, which may be, for example, bandpass filtered to generate a local oscillator signal. Accordingly, the local oscillator signal, which may comprise I and Q components, may range to EHS band frequencies.

### CROSS-REFERENCE TO RELATED APPLICATIONS/INCORPORATION BY REFERENCE

[Not Applicable]

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to wireless communication. More specifically, certain embodiments of the invention relate to a method and system for a programmable local oscillator generator utilizing a DDFS for extremely high frequencies.

### BACKGROUND OF THE INVENTION

Wireless communication has become pervasive throughout our modern society, leading to crowding of allocated communication spectrums. Accordingly, new communication spectrums are being allocated and used for ever increasing applications. As higher transmission frequencies are used, circuitry for modulating signals to be transmitted and demodulating received signals may become more costly.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method for a programmable local oscillator generator utilizing a DDFS for extremely high frequencies, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary wireless system, in accordance with an embodiment of the invention.

FIG. 2A is a block diagram illustrating an exemplary RF receiver front end, in accordance with an embodiment of the invention.

FIG. 2B is a block diagram illustrating an exemplary RF transmitter front end, in accordance with an embodiment of the invention.

FIG. 3 is a block diagram of an exemplary local oscillator generator using DDFS, in accordance with an embodiment of the invention.

FIG. 4 is a block diagram illustrating an exemplary direct digital frequency synthesizer, in accordance with an embodiment of the invention.

FIG. 5 is a flow diagram illustrating exemplary steps for using direct digital frequency synthesizers for extremely high frequencies, in accordance with an embodiment of the invention.

### DETAILED DESCRIPTION OF THE INVENTION

Certain embodiments of the invention may be found in a method and system for a programmable local oscillator generator utilizing a direct digital frequency synthesizer (DDFS) for extremely high frequencies. Aspects of the method may comprise generating a first signal based on a base signal via a DDFS and a second signal based on the base signal. The DDFS may receive communication of one or more frequency control words from, for example, one or more processors, to control generation of the first signal. The first signal and the second signal may be mixed to generate a third signal, where the third signal may comprise a frequency that is a sum of a frequency of the first signal and a frequency of the second signal, and a frequency that is a difference of the frequency of the first signal and the frequency of the second signal. The third signal may be filtered by a bandpass filter to generate a local oscillator signal.

The bandpass filter may be configured to pass either the frequency that is a sum of the frequency of the first signal and the frequency of the second signal, or the frequency that is a difference of the frequency of the first signal and the frequency of the second signal. The bandpass filter may also be configured for a center frequency of a pass band. The first signal and the third signal may each comprise, for example, an in-phase (I) component and a quadrature (Q) component. The base signal may be divided by a divide factor greater than one, for example, to provide a clocking signal that the DDFS may use to generate the first signal. The base signal may also be divided by a divide factor greater than one, for example, to generate the second signal. Accordingly, various frequencies, including frequencies in the extremely high frequency (EHF) spectrum, may be generated.

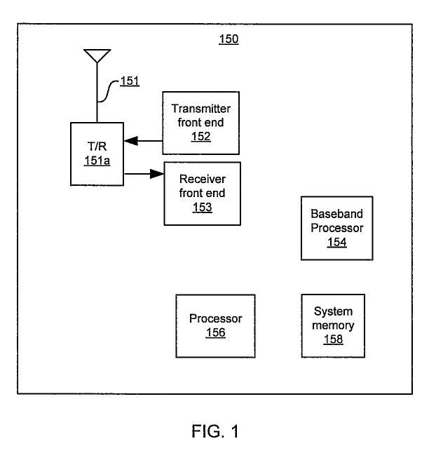

FIG. 1 is a block diagram of an exemplary wireless system, in accordance with an embodiment of the invention. Referring to FIG. 1, the wireless system 150 may comprise an antenna 151, a transmitter/receiver switch 151a, a transmitter front end 152, a receiver front end 153, a baseband processor 154, a processor 156, and a system memory 158. The transmitter/receiver switch 151a may comprise suitable circuitry that enables the antenna 151 to be used for both receiving and transmitting. The transmitter front end (TFE) 152 may comprise suitable logic, circuitry, and/or code that may be adapted to up-convert a baseband signal directly to an RF signal and to transmit the RF signal via the antenna 151. The TFE 152 may also be adapted to up-convert a baseband signal to an IF signal, and/or up-convert the IF signal to a RF signal and then transmit the RF signal via the antenna 151. The TFE 152 may generate, for example, a local oscillator signal that may be used for the up-conversion. The local oscillator signal may be generated up to and including extremely high frequencies using, for example, a programmable local oscillator generator utilizing direct digital frequency synthesizer (DDFS). The TFE 152 may be adapted to execute other functions, for example, filtering the baseband signal, and/or amplifying the baseband signal.

The receiver front end (RFE) 153 may comprise suitable logic, circuitry, and/or code that may be adapted to down-convert a RF signal directly to a baseband signal for further processing. The RFE 153 may also be adapted to down-convert a RF signal to an IF signal, and/or down-convert the IF signal to a baseband signal for further processing. The RFE 153 may generate, for example, a local oscillator signal that may be used for the down-conversion. The local oscillator signal may be generated up to and including extremely high frequencies using, for example, a programmable local oscillator generator utilizing DDFS. The RFE 153 may be adapted to execute other functions, for example, filtering the baseband signal, and/or amplifying the baseband signal.

The baseband processor 154 may comprise suitable logic, circuitry, and/or code that may be adapted to process baseband signals, for example, convert a digital signal to an analog signal, and/or vice-versa. The baseband processor 154 may also provide control, for example, for generating a local oscillator signal using, for example, a programmable local oscillator generator utilizing DDFS. The processor 156 may be a suitable processor or controller such as a CPU or DSP, or any type of integrated circuit processor. The processor 156 may comprise suitable logic, circuitry, and/or code that may be adapted to control the operations of the TFE 152 and/or the baseband processor 154. For example, the processor 156 may be utilized to update and/or modify programmable parameters and/or values in a plurality of components, devices, and/or processing elements in the TFE 152 and/or the baseband processor 154. The processor 156 may also provide control, for example, for generating a local oscillator signal using, for example, a programmable local oscillator generator utilizing DDFS. Furthermore, if the wireless system 150 comprises more than one processor, control and/or data information, which may include the programmable parameters, may be transferred from at least one controller and/or processor to the processor 156. Similarly, the processor 156 may be adapted to transfer control and/or data information, which may include the programmable parameters, to at least one controller and/or processor, which may be part of the wireless system 150.

The processor 156 may utilize the received control and/or data information, which may comprise the programmable parameters, to determine an operating mode of the TFE 152. For example, the processor 156 may be utilized to select a specific frequency for a local oscillator generator, or a specific gain for a variable gain amplifier. Moreover, the specific frequency selected and/or parameters needed to calculate the specific frequency, and/or the specific gain value and/or the parameters needed to calculate the specific gain, may be stored in the system memory 158 via the processor 156. The information stored in system memory 158 may be transferred to the TFE 152 from the system memory 158 via the processor 156. The system memory 158 may comprise suitable logic, circuitry, and/or code that may be adapted to store a plurality of control and/or data information, including parameters needed to calculate frequencies and/or gain, and/or the frequency value and/or gain value.

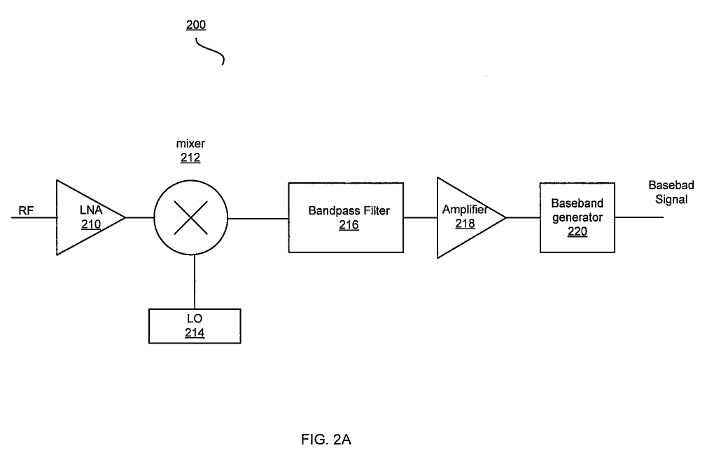

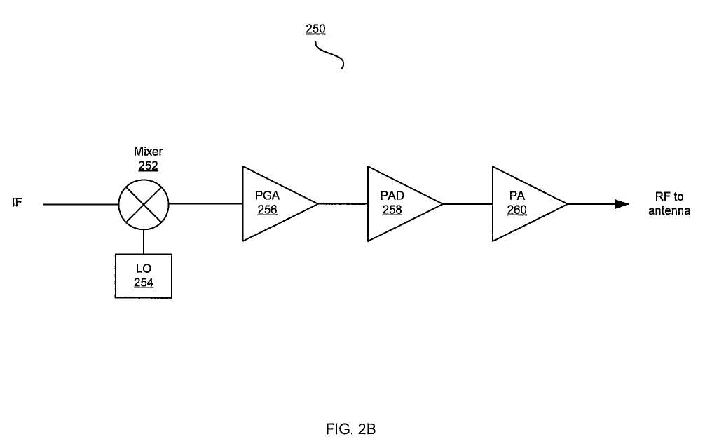

FIG. 2A is a block diagram illustrating an exemplary RF receiver front end, in accordance with an embodiment of the invention. Referring to FIG. 2A, there is shown an exemplary receive path 200 that comprise amplifiers 210 and 218, a mixer 212, a local oscillator (LO) generator 214, a bandpass filter 216, and a baseband generator 220. The amplifiers 210 and 218 may comprise suitable logic, circuitry, and/or code that may be adapted to amplify input signals and output the amplified signals. The amplifier 210 and/or the amplifier 218 may be a low noise amplifier (LNA). A LNA may be utilized in instances where the signal to noise ratio (SNR) may be relatively low, such as, for example, RF signals received by an antenna. The amplifiers 210 and 218 may also be variable gain amplifiers, where the gain control may be, for example, under a programmable control of a processor 156.

The mixer 212 may comprise suitable logic, circuitry, and/or code that may be adapted to receive two input signals, and generate output signals, where the output signals may be a difference of the frequencies of the two input signals and a sum of the frequencies of the two input signals.

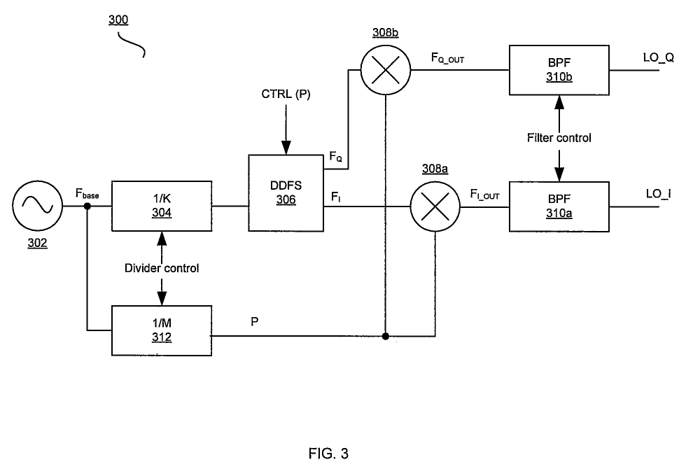

The LO 214 may comprise suitable logic, circuitry, and/or code that may be adapted to output a signal of a specific frequency. The LO 214 is described in more detail with respect to FIGS. 3-5. The bandpass filter 216 may comprise suitable logic, circuitry, and/or code that may be adapted to selectively pass signals within a certain bandwidth while attenuating signals outside that bandwidth.

The baseband generator 220 may comprise suitable logic, circuitry, and/or code that may be adapted to generate analog baseband signal from the IF signal communicated by the amplifier 218. For example, analog down-conversion of the IF signal to analog baseband signal may comprise using a mixer (not shown) similar to the mixer 212. If the baseband processor 154 (FIG. 1) is a digital baseband processor, the analog baseband signal may be converted to digital signal and communicated to the baseband processor 154. An analog to digital converter (ADC) (not shown) may be utilized to digitize the analog IF signal.

Digital down-conversion may comprise digitizing the IF signal, processing the digitized IF signal, for example, filtering and down-converting, to generate a digital baseband signal, which may then be communicated to the baseband processor 154. If the baseband processor 154 is an analog baseband processor, the digital baseband signal may be converted to analog baseband signal and communicated to the baseband processor 154. A digital to analog converter (DAC) (not shown) may be utilized to convert the digital IF signal. The down-conversion of the digital IF signal to the digital baseband signal may utilize, for example, decimation filters where the input frequency of the decimation filter may be a multiple of the output frequency of the decimation filter. The digital filtering of the digital samples may utilize a derotator that may utilize a coordinate rotation digital calculation (CORDIC) algorithm.

In operation, the RF signal, which may have a carrier frequency referred to as f_{RF}, may be received by an antenna and communicated to the amplifier 210, where the RF signal may be amplified by the amplifier 210. The amplified RF signal may be communicated to an input of the mixer 212. The output signal of the LO 214, which may have a frequency of f_{LO}=f_{RF}+f_{IF} or f_{Lo}=f_{RF}−f_{IF}, may be communicated to another input of the mixer 212, where f_{IF} may be a desired intermediate frequency. The mixer 212 may process the two input signals such that the output signal may have a desired frequency. The mixer 212 output signal may be referred to as an IF signal.

The IF signal may be communicated to a bandpass filter 216, which may be adapted to pass the desired bandwidth of signals about the IF frequency f_{IF}, while attenuating the undesired frequencies in the IF signal. The filtered IF signal may be amplified by the amplifier 218, and the amplified IF signal may be communicated to the baseband generator 220. The baseband signal output by the baseband generator 220 may be communicated to the baseband processor 154 for further processing. The processing may comprise, for example, filtering and/or amplifying.

FIG. 2B is a block diagram illustrating an exemplary RF transmitter front end, in accordance with an embodiment of the invention. Referring to FIG. 2B, there is shown an exemplary transmit path 250 that comprises a mixer 252, a local oscillator (LO) generator 254, a programmable gain amplifier (PGA) 256, a power amplifier driver (PAD) 258, and a power amplifier (PA) 260. The mixer 252 may upconvert a baseband signal to RF signal used for transmission using a mixing signal from the LO 254. The LO 254 is described in more detail with respect to FIGS. 3-5. The PGA 256 may amplify an input signal with variable gain to generate an output signal. The gain of the PGA 256 may be adjusted by circuitry and/or a processor, such as, for example, the baseband processor 154 or the processor 156. The PAD 258 and the PA 260 may each amplify an input signal to generate an output signal.

In operation, the input signal to the mixer 252 may be upconverted to radio frequency (RF), and the RF signal from the outputs of the mixer 252 may be communicated to the PGA 256. The mixer 252, the PGA 256, the PAD 258, and the PA 260 may comprise devices that amplify signals, for example. Accordingly, the RF signal may be amplified to a level sufficient for transmission.

FIG. 3 is a block diagram of an exemplary local oscillator generator utilizing DDFS, in accordance with an embodiment of the invention. Referring to FIG. 3, there is shown a local oscillator generator 300 comprising a frequency source 302, divider blocks 304 and 312, DDFS 306, mixers 308a and 308b, and bandpass filters 310a and 310b.

The frequency source 302 may comprise suitable logic and/or circuitry that may enable generation of a base signal F_{base} at a specific frequency. The frequency source 302 may, for example, generate an output signal that may be variable in frequency, where the frequency may be controlled by a voltage signal. The divider blocks 304 and 312 may comprise suitable logic, circuitry, and/or code that may enable receiving an input signal and generating an output signal whose frequency may be divided by a divide factor N, where N may be 1 or more. The output signal generated by the divider block 304 may be used, for example, as a reference clock for the DDFS 306. The divider block 304 or 312 may receive a signal from the frequency source 302 having a frequency Fᵢₙ, and output a signal having a frequency Fₒᵤₜ:

$${F}_{out} = \frac{{F}_{in}}{N} \qquad [ 1 ]$$

where N may represent a divide factor utilized by the divider block 304 or 312. The divide factor N may be, for example, different for the divider block 304 than for the divider block 312. The divide factor N for each of the divider blocks 304 and 312 may be, for example, set to a specific value, or variable. The divide factor N may be determined by, for example, a processor such as the baseband processor 154 and/or the processor 156.

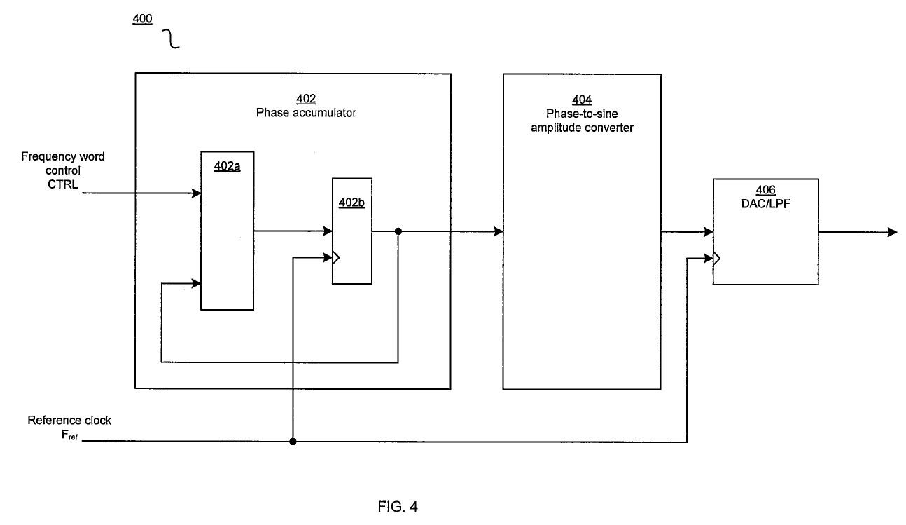

The DDFS 306 may generate at least one output signal that may be used to generate a LO signal for transmission and/or reception of RF signals by the wireless system 150. The DDFS 306 may output, for example, I and Q signals for generating I and Q local oscillator signals. The frequencies of the signals generated by the DDFS 306 may be controlled by, for example, a processor such as the baseband processor 154 and/or the processor 156. Operation of an exemplary DDFS is discussed with respect to FIG. 4.

The mixers 308a and 308b may comprise suitable circuitry that may enable mixing two signals to generate, for example, a signal that may comprise a sum of the frequencies of the two signals and a difference of the two signals. The bandpass filters 310a and 310b may comprise suitable logic and/or circuitry that may enable selecting a particular spectrum of frequencies to pass with minimum attenuation while attenuating frequencies outside that spectrum. The bandpass filters 310a and 310b may be controlled, for example, by the processor 156 and/or the baseband processor 154, to pass certain frequencies.

In operation, the frequency source 302 may generate a signal at a frequency that may be used to generate extremely high frequency (EHF) signals. The frequency source 302 may comprise, for example, a voltage controlled oscillator. The frequency of the frequency source 302 may be controlled by, for example, a processor such as the baseband processor 154 and/or the processor 156. The signal generated by the frequency source 302 may be communicated to the divider blocks 304 and 312.

The divider block 304 may divide the frequency of the input signal by an appropriate divide factor and communicate the reduced frequency signal to the DDFS 306. The divider block 312 may divide the frequency of the input signal by an appropriate divide factor and communicate the reduced frequency signal to the mixers 308a and 308b. Various embodiments of the invention may fix a divide factor by which the divider block 304 and/or the divider block 312 may divide an input frequency. Other embodiments of the invention may allow a divide factor by which the divider block 304 and/or the divider block 312 may divide an input frequency to be variable. For example, the baseband processor 154 and/or the processor 156 may control the factor by which the divider block 304 and/or the divider block 312 may divide an input frequency.

The DDFS 306 may receive the signal from the divider block 304 and may output an in-phase signal F_{I} and a quadrature phase signal F_{Q}. The signals F_{I} and F_{Q}, which may be represented by sin(A) and cos(A), respectively, may be communicated to the mixers 308a and 308b, respectively. The divider block 312 may output a signal P, which may be represented as cos(B), which may be communicated to the mixers 308a and 308b. The mixers 308a and 308b may output signals F_{I}_{_{—}}_{OUT} and F_{Q}_{_{—}}_{OUT}, respectively, where the signal F_{I}_{_{—}}_{OUT} may be represented as sin(A)*cos(B) and the signal F_{Q}_{_{—}}_{OUT} may be represented as cos(A)*cos(B). By using the trigonometric identity equations, the signals F_{I}_{_{—}}_{OUT} and F_{Q}_{_{—}}_{OUT} may be represented as:

F_{I}_{_{—}}_{OUT}=sin(A)*cos(B)=½[ sin(A+B)+sin(A−B)] [2]

F_{Q}_{_{—}}_{OUT}=cos(A)*cos(B)=½[ cos(A+B)+cos(A−B)] [3]

Accordingly, the signal F_{I}_{_{—}}_{OUT} may be 90° out of phase with the signal F_{Q}_{_{—}}_{OUT}. The signal F_{I}_{_{—}}_{OUT} may comprise a sum of the frequencies of the signals F_{I} and P and a difference of the frequencies of the signals F_{I} and P Similarly, the signal F_{Q}_{_{—}}_{OUT} may comprise a sum of the frequencies of the signals F_{Q} and P and a difference of the frequencies of the signals F_{Q} and P.

The signals F_{I}_{_{—}}_{OUT} and F_{Q}_{_{—}}_{OUT} may be communicated to the bandpass filters 310a and 310b, respectively. The bandpass filters 310a and 310b may each filter the input signal appropriately to output signals that may comprise the desired frequencies. For example, the bandpass filters 310a and 310b may be controlled by a processor such as, for example, the baseband processor 154 and/or the processor 156, to select a desired passband spectrum. The bandpass filters 310a and 310b may, for example, be able to perform coarse tuning that may select either the sum of the input frequencies to the mixers 308a and 308b, respectively, or the difference of the input frequencies to the mixers. A center frequency may be specified for the bandpass filters 310a and 310b to perform fine tuning. The center frequency may be specified, for example, by the baseband processor 154 and/or the processor 156. The outputs of the bandpass filters 310a and 310b, LO_I and LO_Q, may have the same frequencies while the phase may be different by 90°. These local oscillator signals may be used by RF receiver front ends and transmitter front ends that process signals whose phases are in quadrature with respect to each other.

While an embodiment of the invention has been described that comprises the divider blocks 304 and 312, the invention need not be so limited. For example, the base signal F_{base} may be communicated to the DDFS 306 and/or the mixers 310a and 310b without being divided by the divider block 304 and/or 312, respectively.

FIG. 4 is a block diagram illustrating an exemplary direct digital frequency synthesizer, in accordance with an embodiment of the invention. Referring to FIG. 4, there is shown a direct digital frequency synthesizer (DDFS) 400 comprising a phase accumulator 402, a phase-to-sine amplitude converter 404, and a digital to analog converter (DAC) 406. The DDFS 400 may be similar in functionality to the DDFS 306. The phase accumulator 402 may comprise an adder 402a that may enable integrating an input signal, such as, for example, a frequency control word CTRL, by adding it to a previous integrated value stored in a register 402b on each cycle of a reference clock F_{ref}. The frequency control word CTRL may be provided by, for example, the processor 156 and/or the baseband processor 154. Various embodiments of the invention may also comprise a control word block (not shown) that may be used to provide the control word. The reference clock F_{ref} may be communicated by, for example, the divider block 304. The reference clock F_{ref} may be fixed-frequency or varying frequency. In the case of a varying reference clock F_{ref}, the change in frequency may be compensated by altering the frequency control word CTRL such that the output of the DDFS may comprise a desired frequency and/or phase.

The phase-to-sine amplitude converter 404 may comprise suitable logic, circuitry, and/or code that may enable converting the output of the phase accumulator 402 to an approximated sine amplitude. For example, the conversion may be achieved via a look-up table. Although only a single output may be shown for exemplary purposes, a plurality of signals may be generated where each signal may be phase shifted from the others. For example, where I and Q signals may be needed, the phase-to-sine amplitude converter 404 may utilize a plurality of different look-up tables for each input value. In an exemplary embodiment of the invention, a first look-up table may be utilized for the I signal and a second look-up table may be utilized for the Q signal.

The DAC 406 may comprise suitable logic and/or circuitry that may enable converting the digital output of the phase-to-sine amplitude converter 404 to an analog output. The DAC 406 may also comprise, for example, a low-pass filter that may be used to “smooth” the analog output. Where the DDFS 400 may generate, for example, I and Q signals, there may be a DAC for generating an I signal and a DAC for generating a Q signal. Accordingly, the DDFS 400 may be a digitally-controlled signal generator that may vary phase, frequency, and/or amplitude of one or more output signals based on a single reference clock F_{ref} and a frequency control word CTRL.

In operation, the frequency control word CTRL may be provided to the adder 402a, and may be successively added to an integrated value stored in the register 402b. The adding may occur, for example, on each cycle of the reference clock F_{ref}. In this manner, the sum may eventually be greater than the maximum value the accumulator can store, and the value in the accumulator may overflow or “wrap”. Accordingly, an N-bit phase accumulator 402 may overflow at a frequency Fₒᵤₜ given by the following equation:

Fₒᵤₜ=(F_{ref}*CTRL)/2^{N} [4]

In this manner, the output of the phase accumulator 402, which may be referred to as Fₒᵤₜ, may be periodic at a period of 1/Fₒᵤₜ and may represent the phase angle of a signal. In this regard, the DDFS 422 may operate as a frequency generator that generates one or more sine waves or other periodic waveforms over a large range of frequencies, from almost DC to approximately half the reference clock frequency F_{ref}.

Prior to changing the frequency control word CTRL, the state of the DDFS 400 may be saved in, for example, a memory such as the system memory 158. In this manner, the output signal Fₒᵤₜ may be interrupted and then resumed without losing the phase information comprising the generated signals. For example, the DDFS 400 may resume generating the output signal Fₒᵤₜ using the saved state loaded from, for example, the system memory 158. Accordingly, the output signal Fₒᵤₜ may resume from the last phase angle transmitted before the signal was interrupted.

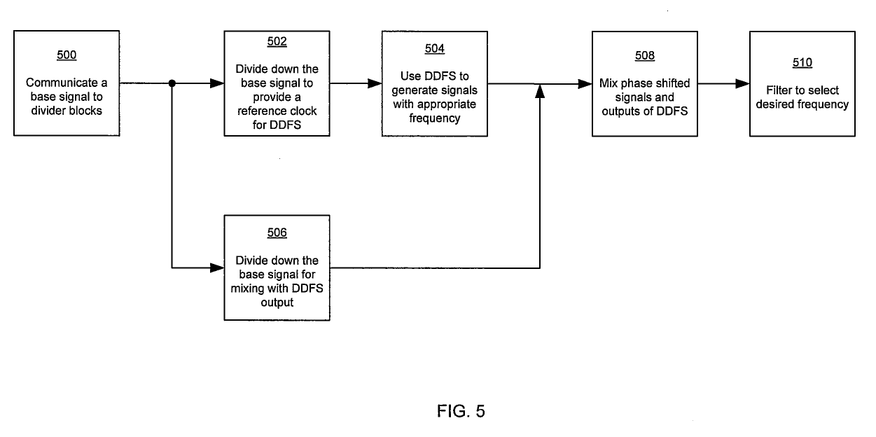

FIG. 5 is a flow diagram illustrating exemplary steps for using direct digital frequency synthesizers for extremely high frequencies, in accordance with an embodiment of the invention. Referring to FIG. 5, there is shown steps 500 to 510. In step 500, the frequency source 302 may generate a base signal F_{base} with a desired frequency, where the desired frequency may be design dependent. The frequency of the base signal F_{base} may be dependent on, for example, a specific carrier channel used for transmission. The frequency of the generated signal may be divided in steps 502 and 506. In step 502, the divider block 304 may reduce the frequency of the input base signal F_{base}, for example, by a divide factor K, such that the output of the divider block 304 may be a signal F_{ref}, where the frequency of the signal F_{ref} may be F_{base}/K. The output signal F_{ref} of the divider block 304 may be communicated to the DDFS 306 as a reference clock.

In step 504, the DDFS 306 may use the reference clock F_{ref} to generate output signals F_{I} and F_{Q}. The frequency of the output signals F_{I} and F_{Q} may depend on the frequency control word CTRL that may be communicated to the DDFS 306 by, for example, the baseband processor 154 and/or the processor 156. The next step from step 504 may be step 508.

In step 506, the divider block 312 may reduce the frequency of the input base signal F_{base}, for example, by a divide factor M, such that the output of the divider block 312 may have a frequency that may be F_{base}/M. The reduced frequency signal from the divider block 312 may be referred to as the signal P. In step 508, the mixer 308a may mix the signals F_{I} and P to generate the signal F_{I}_{_{—}}_{OUT}, and the mixer 308b may mix the signals F_{Q} and P to generate the signal F_{Q}_{_{—}}_{OUT}. The signals F_{I}_{_{—}}_{OUT} and F_{Q}_{_{—}}_{OUT} may have a frequency that may be described by:

F_{I}_{_{—}}_{OUT}=F_{Q}_{_{—}}_{OUT}=F_{base}*((1/M)±(CTRL/(K*2^{N}))) [5]

In step 510, the signals F_{I}_{_{—}}_{OUT} and F_{Q}_{_{—}}_{OUT} may be communicated to the bandpass filters 310a and 310b, respectively. The bandpass filters 310a and 310b may be controlled, for example, by the baseband processor 154 and/or the processor 156, to pass an appropriate frequency spectrum. For example, the bandpass filters 310a and 310b may be controlled to perform coarse tuning to select either the lower frequency F_{base}*((1/M)−(CTRL/(K*2^{N}))) or the upper frequency F_{base}*((1/M)+(CTRL/(K*2^{N}))). The baseband processors 310a and 310b may then be fine tuned to a center frequency. Output signals LO_I and LO_Q of the bandpass filters 130a and 130b, respectively, may be used, for example, for down-conversion in the receiver front end 153 and/or up-conversion in the transmitter front end 152.

In accordance with an embodiment of the invention, aspects of an exemplary system may comprise a DDFS 306 that enables generation of a first signal, which may comprise an in-phase (I) component F_{I} and a quadrature (Q) component F_{Q}, based on a base signal F_{base} from the frequency source 302. The base signal F_{base} may be divided by a divide factor K, for example, by the divider block 304, and the divided signal may be communicated to the DDFS 306. The DDFS 306 may be used to generate a first signal, which may comprise an in-phase (I) component F_{I} and a quadrature (Q) component F_{Q}, which may be based on the base signal. The first signal may be communicated to the mixers 308a and 308b. The base signal may also be communicated to the divider block 312, which may reduce the base signal frequency by a factor M, for example, to generate a second signal. The second signal from the divider block 312 may be communicated to the mixers 308a and 308b.

The mixers 308a and 308b may mix the first signal and the second signal to generate a third signal, which may comprise, for example, the I component signal F_{I}_{_{—}}_{OUT} and the Q component signal F_{Q}_{_{—}}_{OUT}. The third signal may comprise a frequency that is a sum of a frequency of the first signal and a frequency of the second signal, and a frequency that is a difference of the frequency of the first signal and the frequency of the second signal. The bandpass filters 310a and 310b may filter the third signal components F_{I}_{_{—}}_{OUT} and F_{Q}_{_{—}}_{OUT}, respectively to generate the local oscillator (LO) signals LO_Q and LO_Q, respectively. The frequency of the LO signals may be, for example, in the EHF band, where the LO frequency may depend on the output of the frequency source 302, the divider blocks 304 and 312, the frequency control word CTRL for the DDFS 306, and the bandpass filters 310a and 310b.

Another embodiment of the invention may provide a machine-readable storage, having stored thereon, a computer program having at least one code section executable by a machine, thereby causing the machine to perform the steps as described herein for a programmable local oscillator generator utilizing DDFS for extremely high frequencies.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will comprise all embodiments falling within the scope of the appended claims.

What is claimed is:

1. A method for processing signals, the method comprising:
generating via a direct digital frequency synthesizer, a first signal based on a base signal;
generating a second signal based on said base signal; and
mixing said first signal and said second signal to generate a third signal, wherein said third signal comprises a frequency that is a sum of a frequency of said first signal and a frequency of said second signal, and a frequency that is a difference of said frequency of said first signal and said frequency of said second signal.

2. The method according to claim 1, comprising generating a local oscillator signal by filtering said third signal by configuring a bandpass filter to pass one of: said frequency that is a sum of said frequency of said first signal and said frequency of said second signal, and said frequency that is said difference of said frequency of said first signal and said frequency of said second signal.

3. The method according to claim 1, comprising generating a local oscillator signal by filtering said third signal by configuring a bandpass filter for a center frequency.

4. The method according to claim 1, comprising communicating one or more frequency control words to said direct digital frequency synthesizer to control generation of said first signal.

5. The method according to claim 1, comprising dividing said base signal by a divide factor greater than one to generate a clocking signal for said direct digital frequency synthesizer.

6. The method according to claim 1, wherein said second signal is generated by dividing said base signal by a divide factor greater than one.

7. The method according to claim 1, wherein said first signal comprises an in-phase (I) component and a quadrature (Q) component.

8. The method according to claim 1, wherein said third signal comprises an in-phase (I) component and a quadrature (Q) component.

9. A machine-readable storage having stored thereon, a computer program having at least one code section for processing signals, the at least one code section being executable by a machine for causing the machine to perform steps comprising:
generating via a direct digital frequency synthesizer, a first signal based on a base signal;
generating a second signal based on said base signal; and
mixing said first signal and said second signal to generate a third signal, wherein said third signal comprises a frequency that is a sum of a frequency of said first signal and a frequency of said second signal, and a frequency that is a difference of said frequency of said first signal and said frequency of said second signal.

10. The machine-readable storage according to claim 9, wherein the at least one code section comprises code that enables generation of a local oscillator signal by filtering said third signal by configuring a bandpass filter to pass one of: said frequency that is a sum of said frequency of said first signal and said frequency of said second signal, and said frequency that is said difference of said frequency of said first signal and said frequency of said second signal.

11. The machine-readable storage according to claim 9, wherein the at least one code section comprises code that enables generation of a local oscillator signal by filtering said third signal by configuring a bandpass filter for a center frequency.

12. The machine-readable storage according to claim 9, wherein the at least one code section comprises code that enables communication of one or more frequency control words to said direct digital frequency synthesizer to control generation of said first signal.

13. The machine-readable storage according to claim 9, wherein the at least one code section comprises code that enables dividing said base signal by a divide factor greater than one to generate a clocking signal for said direct digital frequency synthesizer.

14. The machine-readable storage according to claim 9, wherein said second signal is generated by dividing said base signal by a divide factor greater than one.

15. The machine-readable storage according to claim 9, wherein said first signal comprises an in-phase (I) component and a quadrature (Q) component.

16. The machine-readable storage according to claim 9, wherein said third signal comprises an in-phase (I) component and a quadrature (Q) component.

17. A system for processing signals, the system comprising:
one or more circuits comprising a direct digital frequency synthesizer, wherein said one or more circuits enable generation of a first signal based on a base signal;
said one or more circuits enable generation of a second signal based on said base signal; and
said one or more circuits comprise one or more mixers that enable mixing of said first signal and said second signal to generate a third signal, wherein said third signal comprises a frequency that is a sum of a frequency of said first signal and a frequency of said second signal, and a frequency that is a difference of said frequency of said first signal and said frequency of said second signal.

18. The system according to claim 17, wherein said one or more circuits comprise one or more bandpass filters, and said one or more circuits enable generation of a local oscillator signal by filtering said third signal, and wherein said one or more bandpass filters are configured to pass one of: said frequency that is a sum of said frequency of said first signal and said frequency of said second signal, and said frequency that is said difference of said frequency of said first signal and said frequency of said second signal.

19. The system according to claim 17, wherein said one or more circuits comprise one or more bandpass filters, and said one or more circuits enable generation of a local oscillator signal by filtering said third signal, and wherein said one or more bandpass filters are configured to generate a local oscillator signal by configuring said one or more bandpass filters for a center frequency for filtering said third signal.

20. The system according to claim 17, wherein said one or more circuits comprise one or more processors that enable communication of one or more frequency control words to said direct digital frequency synthesizer to control generation of said first signal.

21. The system according to claim 17, wherein said one or more circuits comprise a divider that enables dividing said base signal by a divide factor greater than one to generate said first signal that is used as a clocking signal for said direct digital frequency synthesizer.

22. The system according to claim 17, wherein said one or more circuits comprise a divider that enables generation of said second signal by dividing said base signal by a divide factor greater than one.

23. The system according to claim 17, wherein said first signal comprises an in-phase (I) component and a quadrature (Q) component.

24. The system according to claim 17, wherein said third signal comprises an in-phase (I) component and a quadrature (Q) component.
